(19) United States
(12) Patent Application Publication
(10) Pub. No.: US 2012/0120773 A1
(43) Pub. Date: May 17, 2012

(54) Variable Snooze Alarm

(76) Inventor: Daniel Steven O'Toole, Carmel, IN (US)

(21) Appl. No.: 13/296,770

(22) Filed: Nov. 15, 2011

Related U.S. Application Data
(60) Provisional application No. 61/456,825, filed on Nov. 15, 2010.

(51) Int. Cl. G04G 13/02

(52) U.S. Cl. 368/73

(57) ABSTRACT

A system, device and method provides a variable snooze alarm allowing a user to set multiple snooze alarm cycles to begin after an initial time alarm has sounded. In one form, before sleeping, the user can pre set or pre program the number of snooze alarm cycles that the device will go through after an initial alarm has sounded. In another form, during sounding of the initial alarm, the user can set multiple snooze alarm cycles that the device will go through. The variable snooze alarm may include a progressive volume feature that increases the alarm volume for each successive snooze alarm cycle. The variable snooze alarm feature may be provided as part of various devices such as alarm clocks, alarm clock radios, and portable electronic devices. As such, the present variable snooze alarm can run on any operating system and/or platform. It can also be a stand-alone electronic device.

### RELATED APPLICATIONS

This patent application claims the benefit of and/or priority under 35 U.S.C. §119(e) to U.S. Provisional Patent Application Ser. No. 61/456,825 filed Nov. 15, 2010, entitled “Interactive Multi Choice Snooze Alarm” the entire contents of which is specifically incorporated herein by this reference.

### BACKGROUND OF THE INVENTION

1. Field of the Invention

The present invention relates to devices that have a settable alarm for awakening one from sleep and, more particularly, to devices that include a snooze feature in conjunction with a settable alarm for awakening one from sleep that allows a user to immediately silence the alarm and allow the alarm to go off at a later time.

2. Background Information

Clocks have long included a settable alarm for awakening a person at a particular time. Originally, mechanical clocks included one or more bells that would ring when a set alarm time was reached. While the user could turn off the alarm, the bell(s) would eventually stop when the mechanical mechanism wound down. In order to reset the alarm, a new alarm time had to be mechanically set on the clock. With the first electric clocks such as those using split-flap displays, the alarm would not turn off until the user turned it off. Additionally, radios were incorporated into the clocks so that the user could awaken to a particular radio station rather than a buzzer or other electronically produced sound.

With the advent of digital electronic clocks and clock radios, such clocks and clock radios have been equipped with a “snooze button” that allows the user to silence or stop the alarm and add an extra amount of sleeping time by setting the alarm to sound again at a short time later. After that additional time, the alarm again sounds and remains on unless the snooze button is again pressed. The amount of extra sleep time before the alarm sounds again is preset and is most commonly nine minutes.

Therefore, the only way to prolong ones sleep time is to press the snooze button each time the alarm sounds. This causes an interruption in ones desired extended sleep time. Currently, there is no provision given to extend the snooze alarm time period once it expires other than to push the snooze button again.

Additionally, with the growing popularity of portable devices such as MP3 players, iPods, iPads, tablet and notebook computers, cell phones and smart phones having built in clocks and alarms, people are using them as wake up devices. These devices can be set to sound an alarm or play music at a specific time. However, none of these devices include a snooze button or feature as described above. Moreover, the sound volume from these devices is not sufficiently loud to reliably wake the user.

It is thus apparent from the above that this problem has not been properly addressed in alarm clocks and/or portable devices.

It would therefore be desirable to have a snooze alarm that allows a user to program snooze time. Additionally, it would therefore be desirable to allow a variable snooze time after the initial alarm has gone off. Such an arrangement would allow the user to program a pre-selected snooze alarm function that is best suited to that individual's waking requirements.

### SUMMARY OF THE INVENTION

The present invention is a system, device and method for a variable or interactive multi choice snooze alarm (hereinafter and collectively, “variable snooze alarm”). The variable snooze alarm or “Multi Snooze” (as it is known by its commercial name) allows the setting of multiple snooze alarm cycles to begin after an initial time alarm has sounded.

In one form, before sleeping, the user can pre set or pre program the number of snooze alarm cycles that the device will go through after an initial alarm has sounded. In another form, during sounding of the initial alarm, the user can set multiple snooze alarm cycles that the device will go through.

In the first form, the user can pre program or pre set the variable snooze alarm function to provide more than one wake up snooze alarm cycle for the initial wake up alarm. For example, if the user decides that (s)he needs two or more snooze alarm cycles after the initial wake up alarm, (s)he can activate (e.g. press) a snooze programming button the desired two or more times, either before the initial wake alarm is set or thereafter (but before the initial wake alarm sounds); one activation (e.g. press) for each additional snooze cycle interval or period, and those pre set or pre programmed cycles will automatically occur after the initial wake alarm has sounded. If no additional snooze alarm cycles have been pre set or pre programmed before the initial wake alarm has sounded, the snooze button will function as normal and the programmable snooze feature will not be activated. At any time, the user may activate (e.g. press) a snooze stop pad or button which will shut down the snooze function.

In the second form, the user may not desire to pre set or pre program the variable snooze alarm function before the initial wake alarm has sounded, but rather wait and activate the variable snooze function after the initial wake alarm has sounded. Once the initial wake alarm has sounded, the user can then determine if they wish to sleep for an extended time interval or period and, if so, activate (e.g. press) the snooze programming button as many times as desired, each activation or press adding an additional snooze alarm cycle which then accumulate in an uninterrupted manner. For example, if the user presses the snooze programming button three (3) times and the snooze time interval is ten (10) minutes, the snooze alarm will not sound for thirty (30) minutes. At any time, the user may activate (e.g. press) a snooze stop pad or button which will shut down the snooze function. An advantage of this form of the present variable snooze alarm is that upon being awakened, the user can then decide and set multiple snooze alarm cycles all at once, rather than being awakened after each individual prior art snooze sleep cycle and having to press the prior art snooze button each time the cycle completes for an additional snooze cycle.

The variable snooze alarm may allow setting of the snooze time interval or period. A standard ten (10) minute snooze time interval, however, may be a default snooze time interval.

The variable snooze alarm may also include a progressive volume feature that progressively increases the alarm volume for each successive snooze alarm cycle. Thus, the first snooze alarm of the first snooze alarm cycle would sound at a first volume, the second snooze alarm of the second snooze alarm cycle would sound at a second volume that is louder than the first volume, etc. Otherwise, the snooze alarm will sound only after the cumulative number of snooze cycles has ended.

The present variable snooze alarm feature may be provided as part of various devices such as alarm clocks, alarm clock radios, portable devices such as an iPod, tablet computers such as an iPad, notebook computers, general cell phones, smart phones and the like or any electronic device that incorporates the necessary circuitry, memory, programming, controls and speaker to perform the functions and/or features of the present variable snooze alarm. As such, the present variable snooze alarm can run on any operating system and/or platform.

With respect to smart phones and other portable electronic devices that run apps, the present variable snooze alarm is well suited as an app. In the app form, a shake to snooze feature may be provided rather than, or in addition to, a snooze button. A soft wake feature may also be provided that provides an alarm after each snooze alarm cycle has ended rather than at the end of the cumulative number of snooze alarm cycles. The progressive volume feature may also be used along with the soft wake feature.

In all forms, the present variable snooze alarm provides a simple and effective solution for tailoring a wake up time period to suit an individual user.

### BRIEF DESCRIPTION OF THE DRAWINGS

The above mentioned and other features, advantages and/or objects of this invention, and the manner of attaining them, will become apparent and the invention itself will be better understood by reference to the following description of embodiments of the invention taken in conjunction with the accompanying drawings, wherein:

FIG. 1 is a perspective view of an embodiment of a clock having the present variable snooze alarm/feature;

FIG. 2 is a perspective view of a clock radio incorporating a docking platform for a portable device having the present variable snooze alarm/feature;

FIG. 3 is a flow chart of a method according to the present variable snooze alarm/feature;

FIG. 4 is a flow chart of another method according to the present variable snooze alarm/feature;

FIG. 5 is a perspective view of a smart phone having a variable snooze alarm app; and

FIG. 6 is a plan view of a screen from the smart phone variable snooze app.

Like reference numerals indicate the same or similar parts throughout the several figures.

A description of the features, functions and/or configuration of the components depicted in the various figures will now be presented. It should be appreciated that not all of the features of the components of the figures are necessarily described. Some of these non-discussed features, if any, as well as discussed features are inherent from the figures. Other non-discussed features may be inherent in component geometry and/or configuration.

### DETAILED DESCRIPTION OF EMBODIMENTS OF THE INVENTION

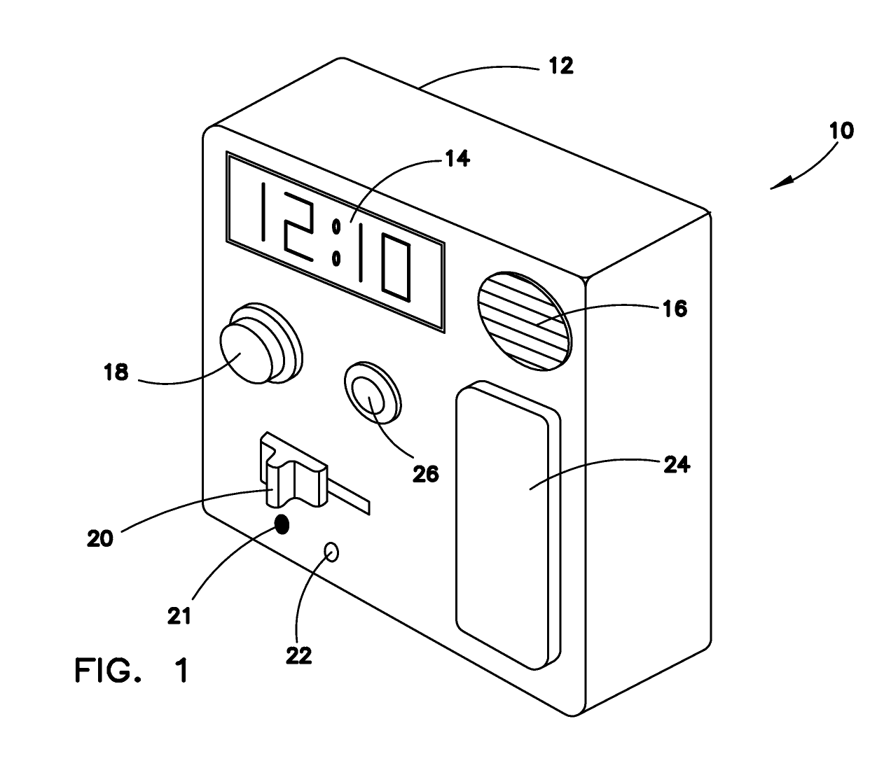

Referring to FIG. 1, there is depicted an alarm clock, generally designated 10, incorporating an interactive multi choice or variable snooze alarm/feature (variable snooze alarm) according to the present principles. The alarm clock 10 has a case 12 housing and/or providing a platform for typical alarm clock features. As such, the alarm clock 10 includes a time display 14, shown as a digital display, but any time display may be used. Typical time set features are also provided although not shown or described. Additionally, since the alarm clock 10 includes an alarm, the alarm clock 10 includes a speaker 16 for audibly sounding or playing the alarm and typical alarm set features although not shown or described. Other typical alarm clock features are included but not shown or described as they, and the other features not shown, are well known in the art. Moreover, while not shown or described, the alarm clock 10, being an electronic clock, includes internal circuitry, programming, etc. typical and necessary for alarm clocks and for providing the present variable snooze alarm, features and/or functions thereof as described herein. The alarm clock 10 may be battery powered and/or operate on A/C power.

The alarm of the alarm clock 10 is set in a conventional manner. In accordance with the present principles, however, the alarm clock 10 includes a variable snooze alarm feature/function as described herein including a snooze alarm cycle/programming button (or other device) 18 that allows a user to activate the present variable snooze alarm in one of two manners. A first manner allows the user to pre set or pre program a number of snooze alarm cycles after the conventional or initial alarm is set and sounded. A second manner allows the user to set a number of snooze alarm cycles after the initial alarm has sounded. In either case, the snooze cycle button 18 is activated or pressed once for each desired snooze alarm cycle. Thereafter, the alarm clock 10 will function to cumulatively add/provide the number of snooze alarm cycle after the initial wake up alarm.

For example, if the user decides for example that (s)he needs two or more snooze alarm cycles after the initial wake up alarm, (s)he can press the snooze cycle button 18 the desired two or more times, either before the initial wake alarm is set or thereafter (but before the initial wake alarm sounds) for the first manner, or after the initial alarm has sounded for the second manner. Each press of the snooze cycle button 18 adds another snooze alarm cycle to the total snooze alarm time period. The total snooze alarm time period defined by the number of pre set or pre programmed snooze alarm cycles will automatically occur after the initial wake alarm has sounded. The snooze alarm will then sound only after the cumulative additive snooze cycle time period has expired. However, in an alternative form, the user may set a soft wake feature that provides an audible sound to the speaker after each snooze alarm cycle has ended.

Once the snooze cycle button 18 has been pressed (either singularly or multiple times), a snooze cycle light 26 turns on indicating that the present variable snooze alarm is active. If a progressive volume to the alarm is desired when the soft wake feature is enabled (or when not enabled, to provide a snooze alarm volume louder than the initial alarm volume), a progressive alarm volume switch 20 may be actuated. In FIG. 1, the progressive alarm volume switch 20 is set in an ON position indicated by the solid dot 21. An OFF position is indicated by a circle 22. Of course, at any time, the user may activate (e.g. press) a snooze stop pad or button 24 which will shut down the snooze function. The snooze alarm is sounded through the speaker 16.

The snooze alarm cycle button 18 may also be used to set the snooze alarm time interval. The snooze alarm time interval is arbitrarily set at a default time period of ten (10) minutes. Other default time periods may be used. In order to change the snooze alarm time interval, one holds down the snooze alarm cycle button 18 for a pre determined time. The display 14 will show the current snooze alarm time interval—which then can be changed using the clock's time set (or other) buttons. The user may select a snooze alarm cycle as between one (1) minute and twenty (20) minutes.

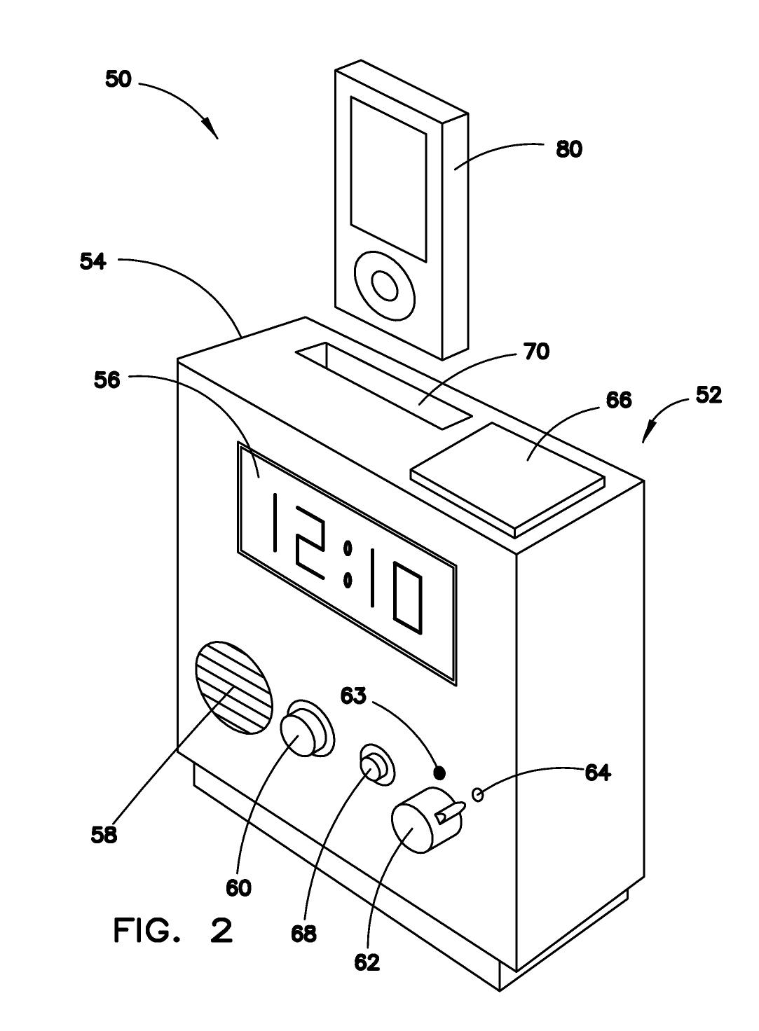

FIG. 2 depicts a combined alarm clock radio and portable device docking station, generally designated 50, having an alarm clock radio/docking station portion 52 incorporating the present variable snooze alarm, feature/function (variable snooze alarm) according to the present principles. The alarm clock radio/docking station portion 52 has a case 54 housing and/or providing a platform for typical alarm clock radio features and a docking bay or slot 70 for an electronic portable device 80. As such, the alarm clock radio/docking station portion 52 includes a time display 56, shown as a digital display, but any time display may be used. Typical time set features are also provided although not shown or described. Radio station function and display may be provided via another display (not shown) and radio controls (not shown). Additionally, since the alarm clock radio/docking station portion 52 includes an alarm, the alarm clock radio/docking station portion 52 includes a speaker 58 for audibly sounding or playing the radio, music, sound file or otherwise from the portable electronic device 80, alarm and typical alarm set features although not shown or described. Other typical alarm clock radio features are included but not shown or described as they, and the other features not shown, are well known in the art. Moreover, while not shown or described, the alarm clock radio/docking station portion 52, being an electronic clock, includes internal circuitry, programming, etc. typical and necessary for alarm clock radios with docking stations and for providing the present variable snooze alarm as described herein. The alarm clock radio/docking station portion 52 may be battery powered and/or operate on NC power.

In like manner to the alarm clock 10 of FIG. 1, the alarm clock radio/docking station portion 52 is set in a conventional manner. In accordance with the present principles, however, the alarm clock radio/docking station portion 52 includes a variable snooze alarm feature/function having a snooze alarm cycle/programming button (or other device) 60 that allows a user to activate the present variable snooze alarm in one of two manners. A first manner allows the user to pre set or pre program a number of snooze alarm cycles after the conventional or initial alarm is set and sounded. A second manner allows the user to set a number of snooze alarm cycles after the initial alarm has sounded. In either case, the snooze cycle button 60 is activated or pressed once for each desired snooze alarm cycle. Thereafter, the alarm clock radio/docking station portion 52 will function to cumulatively add/provide the number of snooze alarm cycle after the initial wake up alarm.

For example, if the user decides for example that (s)he needs two or more snooze alarm cycles after the initial wake up alarm, (s)he can press the snooze cycle button 60 the desired two or more times, either before the initial wake alarm is set or thereafter (but before the initial wake alarm sounds) for the first manner, or after the initial alarm has sounded for the second manner. Each press of the snooze cycle button 60 adds another snooze alarm cycle to the total snooze alarm time period. The total snooze alarm time period defined by the number of pre set or pre programmed snooze alarm cycles will automatically occur after the initial wake alarm has sounded. The snooze alarm will then sound only after the cumulative additive snooze cycle time period has expired. However, in an alternative form, the user may set a soft wake feature that provides an audible sound to the speaker after each snooze alarm cycle has ended.

Once the snooze cycle button 60 has been pressed (either singularly or multiple times), a snooze cycle light 68 turns on indicating that the present variable snooze alarm is active. If a progressive volume to the alarm is desired when the soft wake feature is enabled (or when not enabled, to provide a snooze alarm volume louder than the initial alarm volume), a progressive alarm volume switch 62 may be actuated. In FIG. 2, the progressive alarm volume switch 62 is set in an ON position indicated by the solid dot 63. An OFF position is indicated by a circle 64. Of course, at any time, the user may activate (e.g. press) a snooze stop pad or button 66 which will shut down the snooze function. The snooze alarm is sounded through the speaker 58.

The snooze alarm cycle button 60 may also be used to set the snooze alarm time interval. The snooze alarm time interval is arbitrarily set at a default time period of ten (10) minutes. Other default time periods may be used. In order to change the snooze alarm time interval, one holds down the snooze alarm cycle button 60 for a pre determined time. The display 56 will show the current snooze alarm time interval—which then can be changed using the clock's time set (or other) buttons. The user may select a snooze alarm cycle as between one (1) minute and twenty (20) minutes.

Because the alarm clock radio/docking station portion 52 includes the docking bay 70 for the portable electronic device 80 and the internal electronics as is typical for such devices, the present variable snooze alarm may be programmed into the portable electronic device 80 without the use of the controls on the alarm clock radio/docking station portion 52. The features and functions as described above for the present variable snooze alarm are therefore applicable.

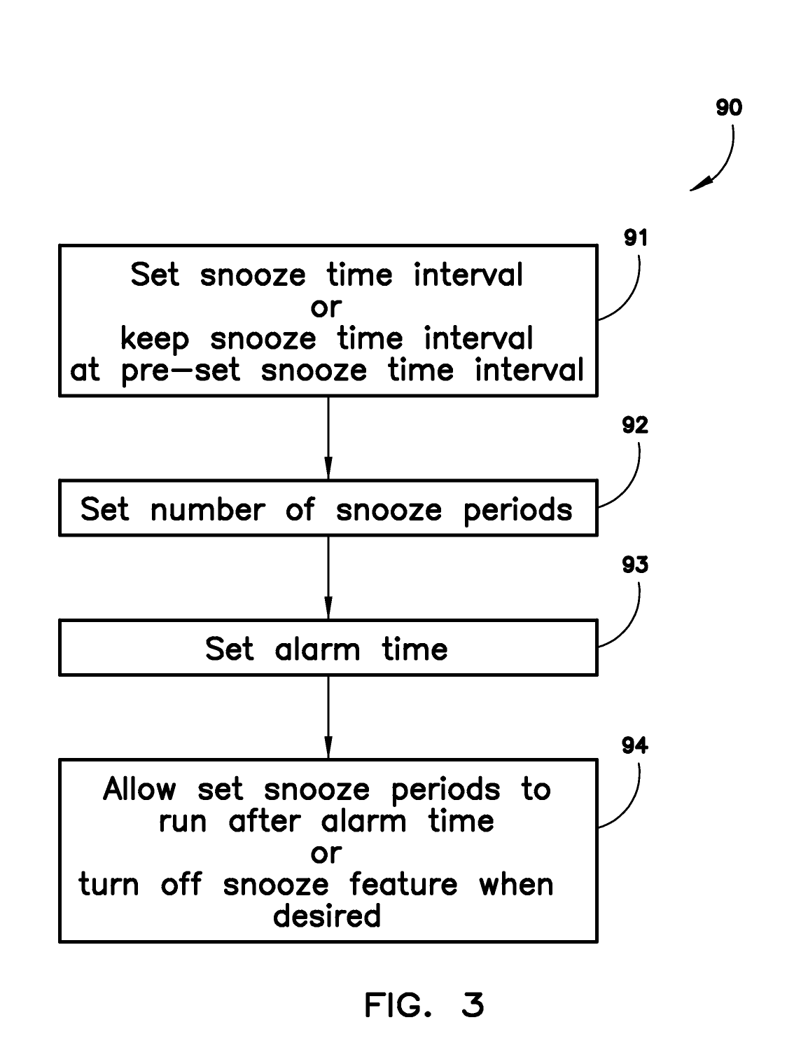

FIG. 3 presents a simple flow chart for the first manner or method 90 of the present variable snooze alarm per the present principles. In step or procedure 91, the user sets a snooze time interval, if desired, or keeps the snooze time interval at the pre-set or default snooze time interval. This is accomplished as described above. In step or procedure 92, the user sets a number of desired snooze periods. Again, this is accomplished as described above. Next, in step or procedure 93, the user sets the initial alarm time such as is typical for an alarm clock or alarm clock radio with or without a docking station, portable electronic device or the like. In step or procedure 94, the user allows the set snooze periods to run after the initial alarm time sounds or turns off the snooze feature when desired. Again, this is accomplished as described above.

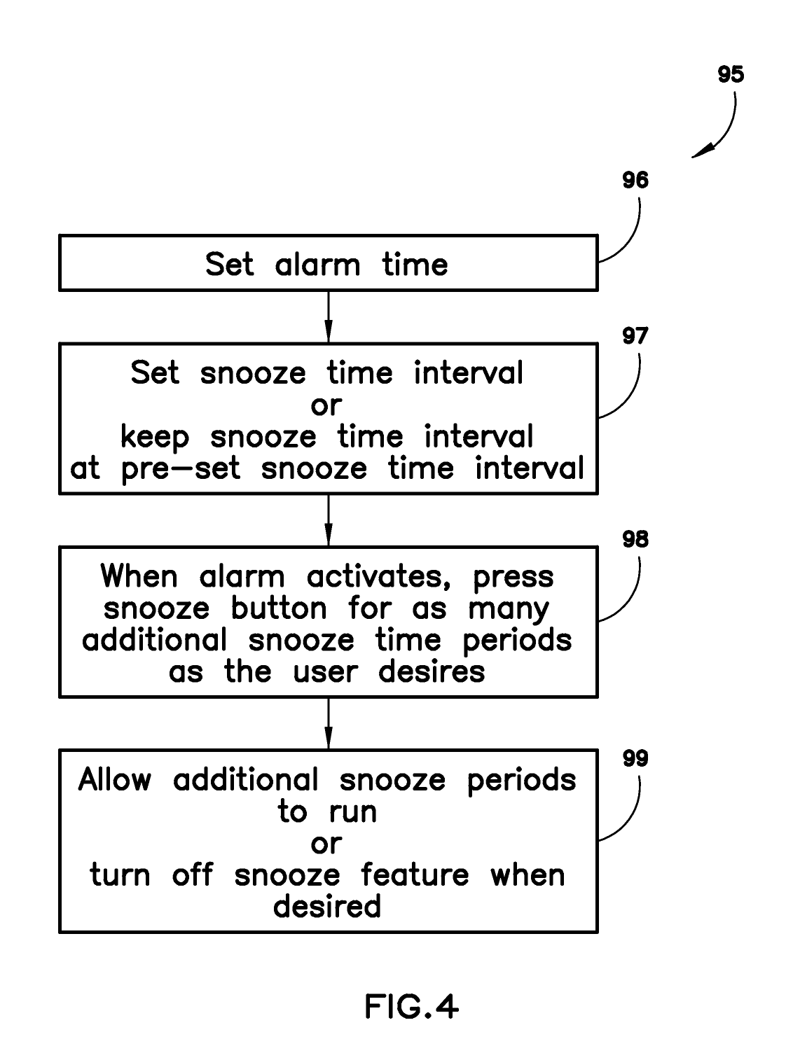

FIG. 4 presents a simple flow chart for the second manner or method 95 of the present variable snooze alarm per the present principles. In step or procedure 96, the user sets the initial alarm time. This is accomplished as described above. In step or procedure 97, the user sets a snooze time interval, if desired, or keeps the snooze time interval at the pre-set or default snooze time interval. Again, this is accomplished as described above. In step or procedure 98, when the initial alarm activates or sounds, the user presses the snooze cycle button for as many additional snooze time periods as desired as described above. In step or procedure 99, the user then allows the snooze periods to run or turns off the snooze feature when desired.

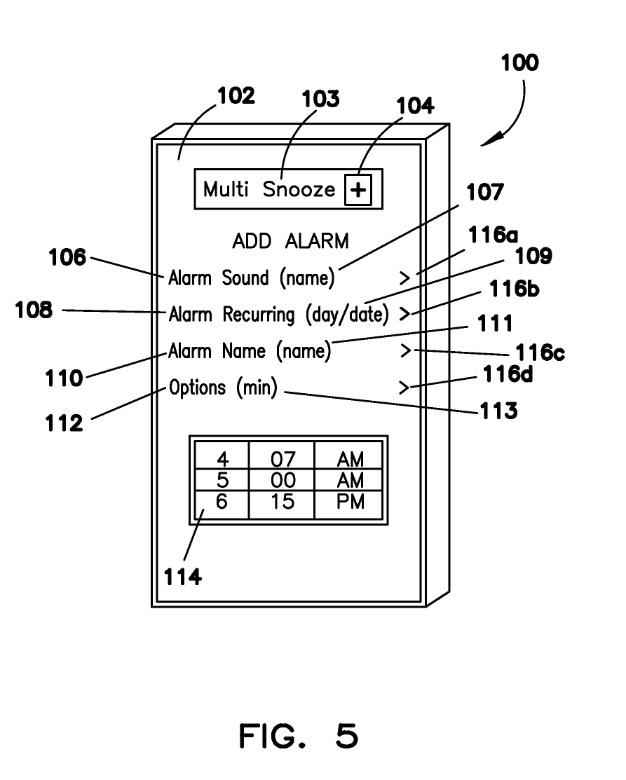

Referring now to FIG. 5, there is depicted a smart phone, generally designated 100, having a variable snooze alarm app in accordance with the principles described herein. The smart phone 100 represents all types of phones and portable electronic devices on which apps may run.

The phone 100 has a touch screen 102 that is shown running the present variable snooze alarm app as identified in an app identifier bar 103, the features, functions and the like as described above with reference to FIGS. 1-4 being incorporated herein. As such, the various buttons, features and/or functions are incorporated into the app and utilized via the touch screen 102 and/or other buttons of the smart phone. The variable snooze alarm app is initiated by pressing the “+” 104. The Add Alarm screen is shown wherein an Alarm Sound bar/menu 106 shows the name 107 of the alarm to use and a carot 116a that takes the user to a typical typing screen (not shown) for selecting the alarm. Various alarms sounds may be stored or downloaded to the device as well as music stored on the smart phone or on the cloud. The Add Alarm screen also has an Alarm Recurring bar/menu 108 that shows the day and/or date 109 for the particular alarm chosen. A carot 116b takes the user to a day/date screen in order to select the recurring day/date for the particular alarm. The Add Alarm screen further has an Alarm Name bar/menu 110 that shows the name 111 for the chosen alarm. Various alarms may be named and stored with the details as shown on the screen, then later recalled as desired. A carot 116c takes the user to a typical typing screen (not shown) for entering and naming the alarm.

The Add Alarm screen moreover has an Options bar/menu 112 that shows the snooze alarm cycle minutes 113 and a carot 116d for taking the user to a snooze alarm cycle screen wherein the user can change the snooze alarm options. The number of snooze cycles may also be selected. The section 114 shows the times of the various snooze cycle alarms.

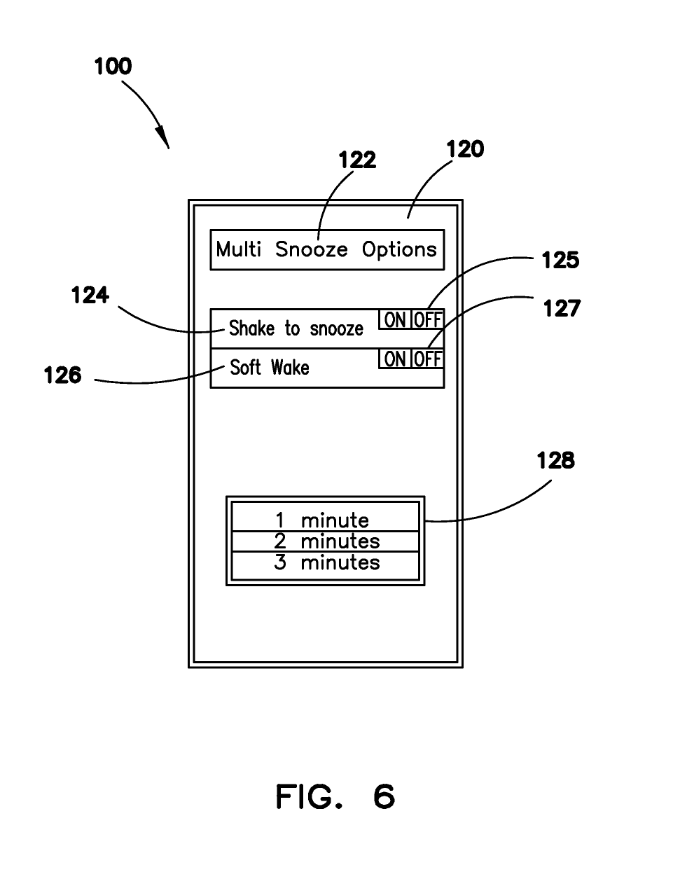

FIG. 6 depicts an Options screen 120 that the carot 116d takes one to. The Options screen 120 provides several options and is identified by a Multi-Snooze (as it is know by its app name) Options bar 122. One option is the Shake to Snooze feature 124. For the Shake to Snooze feature 124, the user has the ability to use an ON/OFF section 125 to turn a Shake to Snooze 124 feature on or off. When the Shake to Snooze feature 124 is ON, instead of pressing the touch screen at a selected spot, the smart phone 100 is shaken once each time to provide the one or more snooze alarm cycles. When the Shake to Snooze feature 124 is OFF, the user must press the snooze button to provide the one or more snooze alarm cycles.

Another option is a Soft Wake feature/function 126. The user has the ability to use an ON/OFF section 127 to turn the Soft Wake 126 feature on and off. When the Soft Wake feature 126 is on, the snooze alarm will sound after each snooze alarm cycle. When the Soft Wake feature 126 is off, the snooze alarm will sound only after the total time intervals/periods of the cumulative snooze alarm cycles has ended. Another option is to change the snooze alarm cycle time interval or period via the time bar/menu 128. While only several time intervals or periods are shown, the snooze alarm cycle time interval or period may be anywhere from one (1) minute to twenty (20) minutes.

While the invention has been illustrated and described in detail in the drawings and foregoing description, the same is to be considered as illustrative and not restrictive in character, it being understood that only preferred embodiments have been shown and described and that all changes and modifications that come within the spirit of the invention are desired to be protected.

What is claimed is:

1. An alarm clock comprising:
a display;
a speaker;
a time settable alarm;
a snooze cycle button allowing a user to set a number of cumulatively additive snooze alarm cycles by activating the snooze cycle button for each desired snooze alarm cycle to create a cumulative snooze time period, each snooze alarm cycle of a snooze alarm time interval; and
electronics coupled to the display for providing time data to the display in order for the display to show time, and coupled to the speaker for 1) providing an initial alarm signal for sounding by the speaker when time has reached the settable alarm time, and 2) providing a snooze alarm signal for sounding by the speaker when the cumulative snooze time period has ended.

2. The alarm clock of claim 1, wherein the snooze cycle button allows the user to set the number of cumulatively additive snooze alarm cycles before the initial audible alarm has sounded.

3. The alarm clock of claim 2, wherein the snooze alarm time interval is settable by the user.

4. The alarm clock of claim 2, further comprising a snooze alarm volume function that progressively increases snooze alarm signal volume for each successive snooze alarm cycle.

5. The alarm clock of claim 1, wherein the snooze cycle button allows the user to set the number of cumulatively additive snooze alarm cycles after the initial audible alarm has sounded.

6. The alarm clock of claim 6, wherein the snooze alarm time interval is settable by the user.

7. The alarm clock of claim 6, further comprising a snooze alarm volume function that progressively increases snooze alarm signal volume for each successive snooze alarm cycle.

8. An alarm clock comprising:
a display;
a speaker;
a docking station configured to receive a portable electronic device;
a time settable alarm;
a snooze cycle button allowing a user to set a number of cumulatively additive snooze alarm cycles by activating the snooze cycle button for each desired snooze alarm cycle to create a cumulative snooze time period, each snooze alarm cycle of a snooze alarm time interval; and
electronics coupled to the display for providing time data to the display in order for the display to show time, coupled to the docking station, and coupled to the speaker for 1) providing an initial alarm signal for sounding by the speaker when time has reached the settable alarm time, and 2) providing a snooze alarm signal for sounding by the speaker when the cumulative snooze time period has ended;
the initial alarm signal and/or the snooze alarm signal utilizing a sound file from the electronic portable device.

9. The alarm clock of claim 8, wherein the snooze cycle button allows the user to set the number of cumulatively additive snooze alarm cycles before the initial audible alarm has sounded.

10. The alarm clock of claim 9, wherein the snooze alarm time interval is settable by the user.

11. The alarm clock of claim 9, further comprising a snooze alarm volume function that progressively increases snooze alarm signal volume for each successive snooze alarm cycle.

12. The alarm clock of claim 8, wherein the snooze cycle button allows the user to set the number of cumulatively additive snooze alarm cycles after the initial audible alarm has sounded.

13. The alarm clock of claim 12, wherein the snooze alarm time interval is settable by the user.

14. The alarm clock of claim 12, further comprising a snooze alarm volume function that progressively increases snooze alarm signal volume for each successive snooze alarm cycle.

15. A snooze alarm app for a smart phone having a display and a speaker, the app comprising:
memory;
programming carried in the memory and providing:
a clock displayable on the display;
a time settable alarm provided on the display;
a snooze cycle button provided on the display allowing a user to set a number of cumulatively additive snooze alarm cycles by pressing the snooze cycle button for each desired snooze alarm cycle to create a cumulative snooze time period, each snooze alarm cycle of a snooze alarm time interval;
an initial alarm signal provided to the speaker for sounding thereby when time has reached the settable alarm time, and
a snooze alarm signal provided to the speaker for sounding thereby when the cumulative snooze time period has ended.

16. The snooze alarm app of claim 15, further comprising programming carried in the memory allowing the user to set the number of cumulatively additive snooze alarm cycles before the initial audible alarm has sounded.

17. The snooze alarm app of claim 15, further comprising programming carried in the memory allowing the user to set the number of cumulatively additive snooze alarm cycles before the initial audible alarm has sounded.

18. The snooze alarm app of claim 15, further comprising programming carried in the memory allowing the user the option to shake the smart phone in place of the snooze button.

19. The snooze alarm app of claim 15, further comprising programming carried in the memory allowing the user the option to have a snooze cycle alarm sound by the speaker after each snooze cycle.

20. The snooze alarm app of claim 15, further comprising programming carried in the memory allowing the user to set the snooze alarm time interval.
